(19) United States
(12) Patent Application Publication
(10) Pub. No.: US 2012/0046942 A1
(43) Pub. Date: Feb. 23, 2012

(54) TERMINAL TO PROVIDE USER INTERFACE AND METHOD

(75) Inventors: Moonsup LEE, Seoul (KR); Sungjin KIM, Goyang-si (KR); Seokgi HONG, Uiwang-si (KR); Taehun KIM, Incheon (KR); Yunseop GEUM, Seoul (KR); Pilwoo LEE, Goyang-si (KR); Dusin JANG, Seoul (KR)

(73) Assignee: PANTECH CO., LTD., Seoul (KR)

(21) Appl. No.: 13/196,806

(22) Filed: Aug. 2, 2011

(30) Foreign Application Priority Data
Aug. 23, 2010 (KR) 10-2010-0081676

(51) Int. Cl. G10L 19/00

(52) U.S. Cl. 704/205; 704/E19.001

(57) ABSTRACT

A terminal and method to determine surrounding circumstances using received sound signals and to automatically control various user interfaces according to the surrounding circumstances. The terminal divides the received sound signals into voice and non-voice signals, analyzes the divide sound signals based on frequencies and determines the circumstances based on the analyzed sound signals. The terminal may further control a user interface based on the determined surrounding circumstances.

### CROSS-REFERENCE TO RELATED APPLICATION

This application claims priority from and the benefit of Korean Patent Application No. 10-2010-0081676, filed on Aug. 23, 2010, which is incorporated by reference for all purposes as if fully set forth herein.

### BACKGROUND

1. Field

The following description relates to an apparatus including a terminal to provide user interfaces based on sound information and a method thereof.

2. Discussion of the Background

Recently, with the rapid development of information communication technology and infrastructures thereof, terminals, such as smart phones, laptop computers, personal digital is assistants (PDAs), tables or kiosks have rapidly come into wide use. A person may make a call to another person using the terminal or acquire a variety of information using the terminal over a communication network.

If a user enters a quiet conference room without changing his/her smart phone to a “manner” or “silent” mode, the smart phone may ring. If a user walks in a noisy street in a state in which a sound volume is set too low, the user may need to increase the sound volume. And, if a user in an emergency may need to press a particular button in order to make an emergency call to the police station, for example, when the user is attacked by a robber.

### SUMMARY

Exemplary embodiments of the present invention provide a terminal for judging surrounding circumstances of a terminal using surrounding sound of the terminal and automatically controlling various user interfaces according to the surrounding circumstances of the terminal, and a method of controlling the same.

Additional features of the invention will be set forth in the description which follows, and in part will be apparent from the description, or may be learned by practice of the invention.

An exemplary embodiment of the present invention discloses a terminal including: an input unit to receive a sound signal of the terminal; a sound source division unit to divide the sound signal received by the input unit according to frequencies; a sound source analysis unit to analyze the sound signal divided by the sound source division unit according to the divided frequencies; a circumstance judgment unit to determine surrounding circumstances of the terminal based on the analyzed result of the sound source analysis unit; and a control unit is to control a user interface of the terminal according to the surrounding circumstances of the terminal determined by the circumstance judgment unit.

An exemplary embodiment of the present invention discloses a method of controlling a terminal, the method including: receiving a sound signal; dividing the received sound signal according to frequencies; analyzing the divided sound signal according to the frequencies; determining surrounding circumstances of the terminal from the analyzed sound signal; and controlling a user interface of the terminal according to the determined surrounding circumstances of the terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram of a terminal according to an exemplary embodiment.

FIG. 2 is a diagram of a sound source division unit according to an exemplary embodiment.

FIG. 3 is a diagram of a sound source analysis unit according to an exemplary embodiment.

FIG. 4a is a diagram of a voice information analysis unit according to an exemplary embodiment.

FIG. 4b is a diagram of a non-voice information analysis unit according to an exemplary embodiment.

FIG. 5 is a flowchart illustrating a method for controlling a terminal according to an exemplary embodiment.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

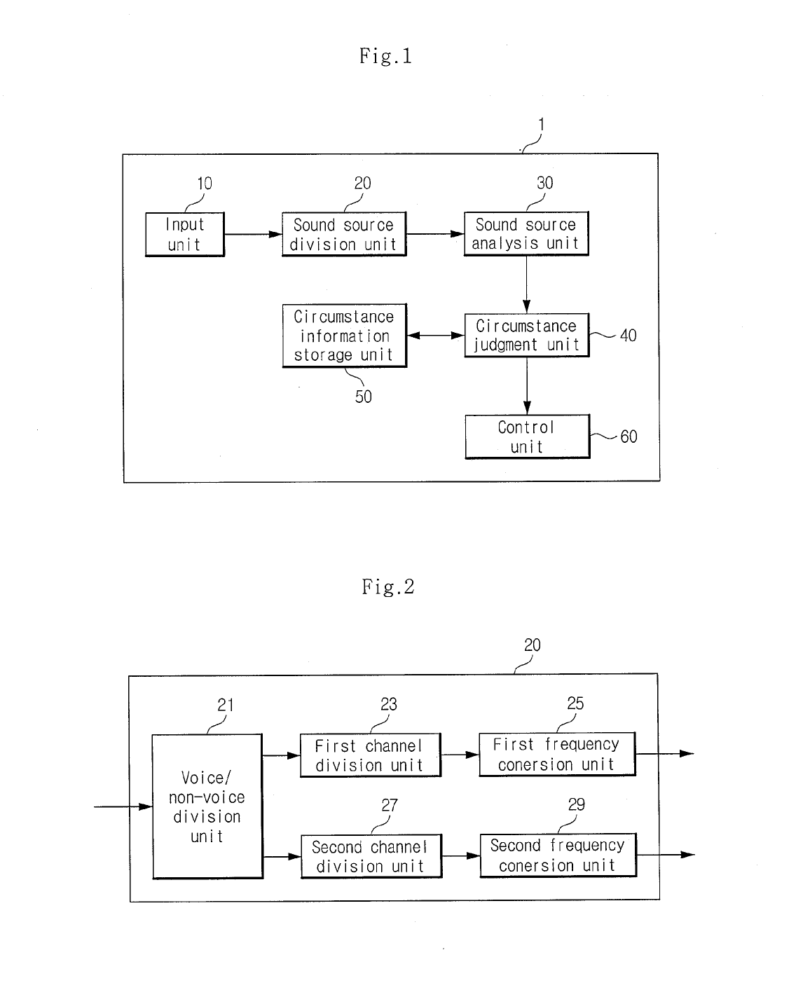

FIG. 1 is a schematic diagram of a terminal according to an exemplary embodiment.

Referring to FIG. 1, a terminal 1 includes an input unit 10, a sound source division unit 20, a sound source analysis unit 30, a circumstance judgment unit 40, a circumstance information storage unit 50, and a control unit 60.

The terminal 1 may be a mobile terminal, such as a smart phone, a laptop computer, tablet computer, or a PDA, or a fixed terminal, such as a kiosk.

The input unit 10 receives a sound signal and includes a microphone array in which a plurality of microphones is arranged. However, aspects of the present invention are not limited thereto, the input unit may receive the sound signal from another device and/or the sound signal may be prerecorded by the terminal or another device.

The sound source division unit 20 divides the sound signal received by the input unit 10 according to frequencies. In exemplary embodiments, the sound source division unit 20 divides the sound signal into a voice signal and a non-voice signal, and the terminal 1 analyzes the divided voice signal and non-voice signal to determine the surrounding circumstances of the terminal 1. The detailed configuration and operation of the sound source division unit 20 will be described with reference to FIG. 2. In exemplary embodiments, the certain frequencies may be established prior to or contemporaneously with the division of the sound signal.

FIG. 2 is a diagram of a sound source division unit according to an exemplary embodiment.

Referring to FIG. 2, the sound source division unit 20 includes a voice/non-voice division unit 21, a first channel division unit 23, a first frequency conversion unit 25, a second channel division unit 27, and a second frequency conversion unit 29.

The voice/non-voice division unit 21 divides the sound signal received by the input unit 10 into a voice signal and a non-voice signal using a frequency division method. In exemplary embodiments, the voice/non-voice division unit 21 may use a voice activity detection (VAD) algorithm to automatically detect a signal section that includes a voice signal. The sound signal received by the input unit 10 may be divided into a section with a voice signal and a section without a voice signal using the VAD algorithm to extract the voice signal and the non-voice signal.

The first channel division unit 23 and the second channel division unit 27 divide the voice signal and the non-voice signal divided by the voice/non-voice division unit 21 according to channels using a frequency division method. As used herein, the division of the voice signal and the non-voice signal according to channels refers to division of the voice signal and the non-voice signal into a plurality of sound sources. That is, since the plurality of sound sources included in the voice signal and the non-voice signal may have different frequency characteristics, the voice signal and the non-voice signal are divided into the sound sources using the frequency characteristics. By way of example, if a voice signal includes sound source information of two or more persons, the voice signal may be divided into the sound sources of the different persons according to channels, and, if a non-voice signal includes a vehicle's engine sound and a ringtone, the non-voice signal may be divided into the vehicle engine sound and the ringtone according to channels.

The first frequency conversion unit 25 and the second frequency conversion unit 29 convert the voice signal and the non-voice signal divided by the first channel division unit 23 and the second channel division unit 27, respectively, into frequency domain information. That is, to determine the surrounding circumstances of the terminal 1 using the divided voice signal and non-voice signal, the signals divided according to channels may be converted into an analyzable data format. In an exemplary embodiment, a method of analyzing a frequency spectrogram including frequency information with time of the signals divided according to channels and thereby detecting signal characteristics is used. Various algorithms for converting a signal into a frequency domain may be used. In an exemplary embodiment, the first frequency conversion unit 25 and the second frequency conversion unit 29 of the terminal 1 use a short-time Fourier transform (STFT) algorithm, which is one of numerous Fourier transform algorithms.

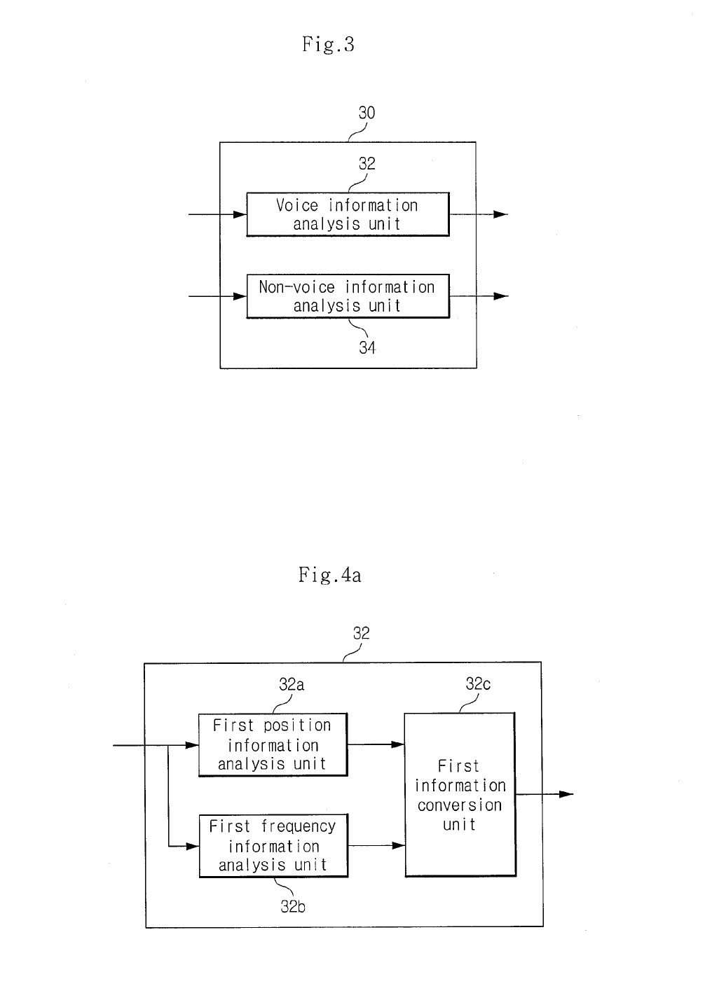

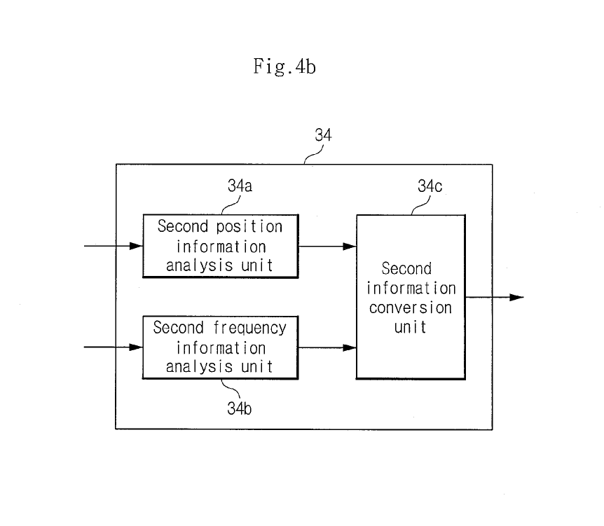

Referring again to FIG. 1, if the voice signal and the non-voice signal are divided according to channels and converted into the frequency domain information in the sound source division unit 20, the sound source analysis unit 30 analyzes sound source associated information based on the frequency domain information. The configuration and operation of the sound source analysis unit 30 will be described in detail with reference to FIG. 3 and FIG. 4.

FIG. 3 is a diagram of a sound source analysis unit according to an exemplary embodiment.

Referring to FIG. 3, the sound source analysis unit 30 includes a voice information analysis unit 32 and a non-voice information analysis unit 34. The voice information analysis unit 32 analyzes the voice signal divided by the sound source division unit 20. The non-voice information analysis unit 34 analyzes the non-voice signal divided by the sound source division unit 20.

FIG. 4a is a diagram of a voice information analysis unit according to an exemplary embodiment.

Referring to FIG. 4a, the voice information analysis unit 32 includes a first position information analysis unit 32a, a first frequency information analysis unit 32b and a first information conversion unit 32c.

The first position information analysis unit 32a analyzes position and direction information of sound sources included in the voice signal divided by the voice/non-voice division unit 21. The first position information analysis unit 32a estimates the positions and directions of the sound sources using arrival time information of the signals received by the microphone array, i.e., input unit 10, and the amplitude information of the frequency of the signals.

The first frequency information analysis unit 32b analyzes frequency information of sound sources included in the voice signal divided by the voice/non-voice division unit 21. The first frequency information analysis unit 32b analyzes the frequency spectrogram of the voice signal acquired by the first frequency conversion unit 25 and analyzes sound source information, such as sound level, type and feeling.

The first information conversion unit 32c converts the information analyzed by the first position information analysis unit 32a and the first frequency information analysis unit 32b into an information format available to the circumstance judgment unit 40. That is, the data generated by the first position information analysis unit 32a and the first frequency information analysis unit 32b may be processed to be useable by the circumstance judgment unit 40 to determine the surrounding circumstance of terminal 1.

FIG. 4b is a diagram of a non-voice information analysis unit according to an exemplary embodiment.

Referring to FIG. 4b, the non-voice information analysis unit 34 includes a second position information analysis unit 34a, a second frequency information analysis unit 34b and a second information conversion unit 34c.

The second position information analysis unit 34a analyzes position and direction information of sound sources included in the non-voice signal divided by the voice/non-voice division unit 21. The second frequency information analysis unit 34b analyzes frequency information of sound sources included in the non-voice signal divided by the voice/non-voice division unit 21. The second information conversion unit 34c converts the information analyzed by the second position information analysis unit 34a and the second frequency information analysis unit 34b into an information format useable by the circumstance judgment unit 40.

If the sound source information included in the voice signal and the non-voice signal is analyzed by the sound source analysis unit 30, the circumstance judgment unit 40 determines the surrounding circumstances of the terminal 1 based on this information. An exemplary method of determining the surrounding circumstances of the terminal 1 by the circumstance judgment unit 40 is described below.

Referring to FIG. 1, the circumstance judgment unit 40 receives the analyzed information, i.e., the sound source information, from the sound source analysis unit 30 and determines the surrounding circumstances of the terminal 1 based on the analyzed information by accessing the circumstance information storage unit 50. The circumstance information storage unit 50 is a database in which circumstance information corresponding to sound signal information of the terminal 1 may be stored. Circumstance information corresponding to different types of sound information is stored in the circumstance information storage unit 50. By way of example, sound information of a specified decibel level (dB) may be stored in the circumstance information storage unit 50 as circumstance information of a noisy environment.

The circumstance judgment unit 40 receives the information analyzed by the sound source analysis unit 30 and determines whether the analyzed information is stored in the circumstance information storage unit 50. The circumstance judgment unit 40 retrieves circumstance information if the information analyzed by the sound source analysis unit 30 matches information stored in the circumstance information storage unit 50, and transmits the circumstance information to the control unit 60. If the analyzed information is not stored in the circumstance information storage unit 50, the analyzed information is stored in the circumstance information storage unit 50 as new database information. At this time, the circumstance information corresponding to the analyzed sound information may be learned from an environment setup specified or used by a user and may be stored in the circumstance information storage unit 50.

The control unit 60 controls a user interface (UI) of the terminal based on the surrounding circumstances of the terminal 1 determined by the circumstance judgment unit 40. As used herein, the term “user interface” includes a graphic user interface (GUI) of a display unit of the terminal 1, an interface associated with basic environment setup and driving of a terminal, such as ringtone setting, Short Message Service (SMS) setting or “manner” or “silent” mode setting, and an interface associated with environment setup and driving of an application executed by the terminal 1.

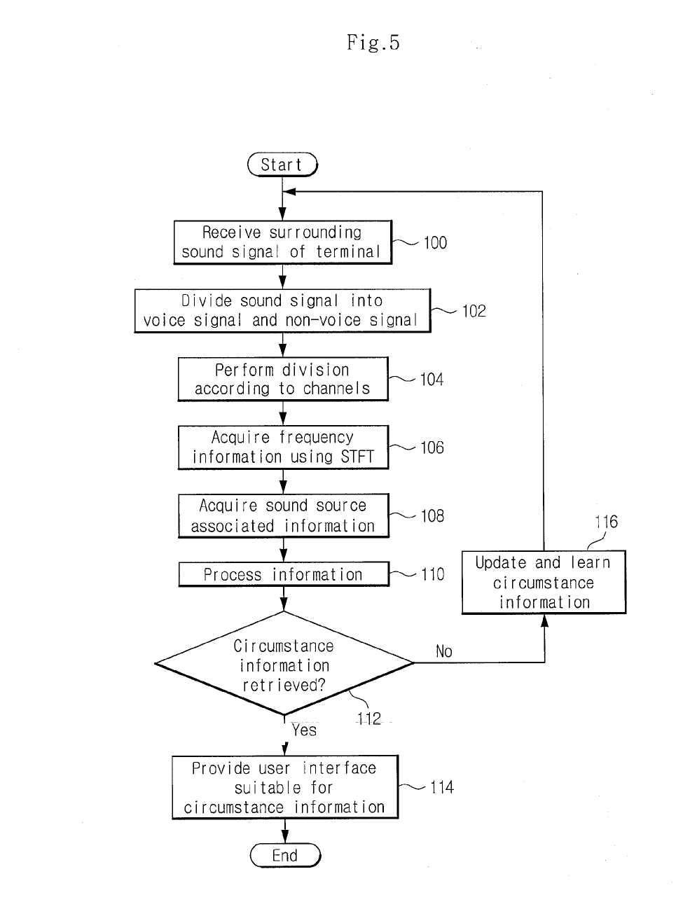

Hereinafter, the method for controlling the terminal 1 according to an exemplary embodiment will be described with reference to FIG. 5. Exemplary embodiments in which the control unit 60 controls the UI will be described for illustrative purposes.

FIG. 5 is a flowchart illustrating a method for controlling a terminal according to an exemplary embodiment.

Referring to FIG. 5, in operation 100, while the terminal 1 is operational, the input unit 10 receives a sound signal of the terminal 1. The input unit 10 transmits the received sound signal of the terminal 1 to the sound source division unit 20. In operation 102, the voice/non-voice division unit 21 of the sound source division unit 20 divides the received sound signal into a voice signal and a non-voice signal. However, aspects are not limited thereto such that both types of signals are not needed. In operation 104, the first channel division unit 23 and the second channel division unit 27 perform division according to channels that divides the voice signal and the non-voice signal into sound sources according to channels using a frequency division method. In operation 106, the first frequency conversion unit 25 and the second frequency conversion unit 29 acquire frequency spectrogram information using an STFT algorithm from the sound source information divided according to channels.

In operation 108, the sound source analysis unit 30 acquires sound source associated information, such as the positions, types and levels, of the sound sources using the frequency spectrogram information. In operation 110, the sound source analysis unit 30 processes the sound source associated information into data formats useable by the circumstance judgment unit 40.

In operation 112, the control unit 60 receives the sound source associated information from the sound source analysis unit 30, compares the received sound source associated information with the circumstance information stored in the circumstance information storage unit 50, and determines whether or not circumstance information is retrieved. If the circumstance information is retrieved, in operation 114, the control unit 60 provides a user interface suitable for the circumstance information to a user through the terminal 1.

If the circumstance information is not retrieved, in operation 116, the control unit 60 updates and learns circumstance information. The control unit may store the sound source associated information received through the sound source analysis unit 30 in the circumstance information storage unit 50 as new database information, learn the control environment of the terminal 1 specified or used by the user, and store the terminal control environment as UI information corresponding to the circumstance information.

In this way, the terminal 1 according to an exemplary embodiment automatically controls the UI using the sound information of the terminal 1 to provide a more convenient use environment of the terminal 1 to the user. In the control of the UI using the sound information of the terminal 1, any UI described above may be used. Examples of the UI may include a background screen interface, an illumination interface, a volume interface, a vibration interface, an application interface, and the like. Hereinafter, several exemplary embodiments of the control of the UI will be described.

(1) UI which is Changed According to Surrounding Atmosphere

A surrounding atmosphere may be determined by measuring a ratio of frequency components of sound sources of sound information of the terminal 1. For example, if the sound sources of the terminal 1 include a large number of sound signals each having a low frequency band, it may be determined that the surrounding atmosphere is quiet. In this case, a “comfortable” background screen may be provided as well as a soft backlight for an illumination unit of a keypad. In this way, the surrounding atmosphere of the terminal may be determined using the intensity information, the frequency information, etc. of the sound signal, and an emotional UI corresponding to the surrounding circumstances may be provided to a user.

(2) Mobile Phone Setup which is Changed According to Surrounding Circumstances

A UI may be controlled according to surrounding circumstances such that the terminal 1 suits surrounding circumstances. For example, if a user of the terminal 1 walks on a noisy street, the volume interface may be controlled such that the ringtone and the sound volume are set high and, if a user of the terminal 1 is in a quiet space such as a theater or a conference room, a “manner” or “silent” mode may be automatically executed. The UI associated with the mobile phone setup controlled by the control unit 60 of the terminal 1 may include a background screen interface, an illumination interface, a volume interface, a vibration interface, and the like.

(3) Recognition of Sound of Transportation and Provision of Service Suitable for Circumstances

Car, bus and airplane sound signals may be distinguished using a difference between intensities of the engine sound of the corresponding transportation to determine which transportation type is currently being used by a user, and a UI suitable for the transportation type may be controlled. For example, if it is determined that the user is driving a private car, if a message is received, a Text to Speech (TTS) mode may be executed to read aloud the message. If the user receives a phone call, the phone may be switched to a handsfree mode or a speakerphone mode.

If it is determined that the user is using public transportation, such as a bus, subway or train, a Global Positioning System (GPS) may be operated to determine the position of the user, and a UI capable of providing geographical information appropriate for the position of the user may be automatically executed on a background screen to provide a destination alarm or tourism information. If it is determined that the user is using an airplane, a flight mode for automatically preventing signal transmission/reception may be executed in order to prevent malfunction of a communication apparatus of the airplane.

(4) Provision of UI for Emergency

The control unit 60 of the terminal 1 may recognize an urgent sound of a user and control a UI according to the emergency. That is, the sound information of the terminal 1 may be analyzed to determine whether or not the user is in an emergency. If the user is determined to be in an emergency, an alarm sound or an alarm message may be automatically generated and an emergency call may be automatically made to the police station or fire station. In an exemplary embodiment, a sound pattern of a high-crime area may be stored in advance, and, if it is is determined that the user is in the high-crime area, an emergency standby mode may be executed to provide rapid use of the terminal in an emergency.

(5) Service for Providing Price Information in a Shop

If voice information of a specific item, such as an on-sale product, is recognized from the sound information of the terminal 1, a user may be informed of the position or the like of the on-sale product. In addition, the lowest price of the same product in nearby shops may be automatically retrieved and may be provided in association with a positional information service of a GPS.

(6) Guide Service for Disabled Person

If a user of the terminal 1 is a hearing-impaired person, a situation which may put the user in danger may be sensed in advance from a sound signal and the user may be informed of the dangerous situation through vibration or visual indication. That is, information about persons, vehicles, or mobile objects around the user may be acquired from the sound information of the terminal 1 and may be provided to the user using an interface method, such as vibration, light, a display unit, alarm sound, or the like.

(7) UI Control Through Sound Pattern Recognition

A user may store a specific sound source pattern and an operation specified by the user may be executed if the sound information of the specific pattern is recognized. For example, if a user snaps his or her thumb and finger, music may be played. In an exemplary embodiment, a hold mode may be released when the user claps.

(8) Guide Service in Museum

If sound information of exhibits in a museum is recognized, information about the exhibits may be provided. For example, if a lions roar is recognized while a user is touring in a safari park, information about lion may be provided visually through the display unit of the terminal 1 or may be provided audibly through a speaker.

The above-described examples of the UI are only exemplary examples of UIs

The terminal and the method, according to aspects of the present invention may automatically provide a suitable UI to a user without an additional operation by the user because the surrounding circumstances of the terminal are determined using the sound information of the terminal and the UI of the terminal is controlled according to the surrounding circumstances of the terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
an input unit to receive a sound signal;
a sound source division unit to divide the sound signal received by the input unit according to frequencies;
a sound source analysis unit to analyze the sound signal divided by the sound source division unit according to the divided frequencies;
a circumstance judgment unit to determine surrounding circumstances of the terminal based on the analyzed result of the sound source analysis unit; and
a control unit to control a user interface of the terminal according to the surrounding circumstances of the terminal determined by the circumstance judgment unit.

2. The terminal according to claim 1, wherein the input unit is a microphone array.

3. The terminal according to claim 1, wherein the sound source division unit comprises:
a voice/non-voice division unit to divide the sound signal received by the input unit into a voice signal and a non-voice signal; and
a channel division unit to divide the signals divided by the voice/non-voice signal division unit according to channels using a frequency division method.

4. The terminal according to claim 3, wherein the sound source division unit further comprises a frequency conversion unit configured to convert the signals divided by the channel division unit into frequency domain information.

5. The terminal according to claim 3, wherein the sound source analysis unit comprises a voice information analysis unit and a non-voice information analysis unit configured to respectively analyze the voice signal and the non-voice signal divided by the voice/non-voice division unit.

6. The terminal according to claim 5, wherein the voice information analysis unit comprises:
a position information analysis unit to analyze position and direction information of the voice signal divided by the voice/non-voice division unit; and
a frequency information analysis unit to analyze frequency information of the voice signal divided by the voice/non-voice division unit.

7. The terminal according to claim 5, wherein non-voice information analysis unit comprises:
a position information analysis unit to analyze position and direction information of the non-voice signal divided by the voice/non-voice division unit; and
frequency information analysis unit to analyze frequency information of the non-voice signal divided by the voice/non-voice division unit.

8. The terminal according to claim 6, wherein the voice information analysis unit comprises an information conversion unit to convert the information analyzed by the position information analysis unit and the frequency information analysis unit into an information format available to the circumstance judgment unit.

9. The terminal according to claim 7, wherein the non-voice information analysis unit comprises an information conversion unit to convert the information analyzed by the position information analysis unit and the frequency information analysis unit into an information format available to the circumstance judgment unit.

10. The terminal according to claim 1, further comprising a circumstance information storage unit to store circumstance information corresponding to the sound signal of the terminal, wherein the circumstance judgment unit compares the result analyzed by the sound source analysis unit with the circumstance information stored in the circumstance information storage unit and determines the surrounding circumstances of the terminal.

11. The terminal according to claim 1, wherein the control unit controls at least one of a background screen interface of a display unit of the terminal, an illumination interface of the terminal, a volume interface of the terminal and a vibration interface of the terminal, according to a surrounding noise level of the terminal determined by the circumstance judgment unit.

12. The terminal according to claim 1, wherein the control unit controls at least one of a background screen interface of a display unit of the terminal, an illumination interface of the terminal, a volume interface of the terminal and a vibration interface of the terminal, according to a mode of transportation determination made by the circumstance judgment unit.

13. The terminal according to claim 12, wherein the control unit executes a Text to Speech (TTS) mode if a message is received through the terminal or executes a handsfree mode or a speakerphone mode if a user receives a phone call, if the mode of transportation is determined to be a private car.

14. The terminal according to claim 12, wherein the control unit detects the position of a user of the terminal and controls a user interface to provide the user with a geographical information corresponding to the detected position of the terminal through a display unit, a speaker or a vibration unit of the terminal, if the mode of transportation is determined to be public transportation.

15. The terminal according to claim 12, wherein the control unit switches an operation mode of the terminal to a flight mode to prevent signal transmission and reception, if the mode of transportation is determined to be an airplane.

16. The terminal according to claim 1, wherein the control unit generates an alarm sound or an alarm message or automatically makes an emergency call, if the circumstance judgment unit determines that a user of the terminal is in an emergency.

17. The terminal according to claim 1, wherein the control unit provides a user with information about the surrounding circumstances of the terminal determined by the circumstance judgment unit through at least one of a display unit, a speaker, an illumination unit and a vibration unit of the terminal, and combinations thereof.

18. The terminal according to claim 1, wherein the control unit executes a user interface established by a user of the terminal, if the circumstance judgment unit determines that sound source information of the terminal matches a pattern established by the user.

19. A method for controlling a terminal, the method comprising:
receiving a sound signal;
dividing the received sound signal according to frequencies;
analyzing the divided sound signal according to the frequencies;
determining surrounding circumstances of the terminal from the analyzed sound signal; and
controlling a user interface of the terminal according to the determined surrounding circumstances of the terminal.

20. The method according to claim 19, wherein the dividing of the received sound signal according to the frequencies comprises dividing the received sound signal into a voice signal and a non-voice signal.

21. The method according to claim 19, wherein the analyzing the divided sound signal comprises analyzing at least one of an intensity information, a frequency information, a position information and a direction information of the divided sound signal according to the frequencies, and combinations thereof.

22. The method according to claim 19, wherein the controlling of the user interface of the terminal comprises controlling at least one of a background screen interface of a display unit of the terminal, an illumination interface of the terminal, a volume interface of the terminal, a vibration interface of the terminal, and an application interface of the terminal, and combinations thereof.
